(19) United States
(12) Patent Application Publication
(10) Pub. No.: US 2010/0282958 A1
(43) Pub. Date: Nov. 11, 2010

(54) METHOD FOR OPERATING AN FTIR SPECTROMETER, AND FTIR SPECTROMETER

(75) Inventors: Norbert WILL, Nidderau (DE); Bernd Hielscher, Bad Vilbel (DE); Christoph Becker, Frankfurt (DE); Berthold Andres, Biebergemuend (DE); Carsten Rathke, Schoeneck (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/784,757

(22) Filed: May 21, 2010

Related U.S. Application Data
(63) Continuation of application No. PCT/EP2008/009854, filed on Nov. 21, 2008.

(30) Foreign Application Priority Data
Nov. 22, 2007 (DE) 10 2007 056 345.2

(51) Int. Cl. G01N 21/35; G12B 13/00

(52) U.S. Cl. 250/252.1; 250/339.08

(57) ABSTRACT

An FTIR (Fourier transformation infrared) spectrometer is disclosed, wherein a validation/calibration of the spectrometer can be carried out in cyclically recurring intervals. Using at least two temporarily available gases, a reference spectrum with a zero gas and an absorption spectrum with a calibration gas are recorded. Substitute gases can be used during validation of the spectrometer as gas components, the substitute gases simulating actual measured gas components with respect to metrological properties.

### RELATED APPLICATIONS

This application claims priority as a continuation application under 35 U.S.C. §120 to PCT/EP2008/009854, which was filed as an International Application on Nov. 21, 2008 designating the U.S., and which claims priority to German Application 102007056345.2 filed in Germany on Nov. 22, 2007. The entire contents of these applications are hereby incorporated by reference in their entireties.

### FIELD

The disclosure relates to a method for operating an FTIR spectrometer, and FTIR spectrometers themselves.

### BACKGROUND INFORMATION

FTIR spectrometers are infrared spectrometers operating with a Fourier transform calculation method. Spectrometers of this type do not operate on specific absorption lines but rather record a spectrum of an entire wavelength range and thus obtain, using a mathematical spectrometer function, information relating to the absorptions over the examined frequency or wavelength spectrum. On the basis of the distribution obtained, a chemometric examination is subsequently carried out and the distribution is associated with the corresponding gas components. It is thus possible for a plurality of gas components to be measured at the same time using the FTIR spectrometer.

In order to go through an entire frequency range, an interferometric construction having moveable mirrors is used, for example according to Michelson.

In order to address equipment-based drift, for example as is caused by changes in the transmission behavior, calibrations and validations have been carried out regularly. This technique is used to provide reliability of the measurement results. This may be simple in the case of easy-to-handle gas components like CO or CO₂. FTIR spectrometers, however, are also of interest in the case of gases which are difficult to handle. Examples of this are NH₃, HCl, HF, H₂O.

An advantage of FTIR spectrometers, however, is that many gas components can be measured at the same time. Spectrometers of this type are thus also suitable for emission measurements. The spectrometer can be checked every day.

When checking the calibration data (validation), two steps have been carried out: at short intervals (e.g., daily), regular recording of a reference spectrum is carried out with zero gas (such as purified ambient air). This reference spectrum is used to compensate for changes in the transmission behavior of the system. Changes in the transmission behavior can be caused, for example, by impurities in the optical path, change in emitter output, change in the detector or by impurities on the measurement cell. The compensation of the zero point is carried out in a wavelength-dependent manner, and with this the zero point is corrected for all components at the same time.

At longer intervals (e.g., weekly to yearly), the reference points for all components are regularly validated (checked) and, if appropriate, calibrated with test gas. Gases which are easy to handle, such as CO, CO₂, NO, can be calibrated without additional aids with test gases in test gas cylinders. For components which are difficult to handle in test gas cylinders, such as H₂O or HCl, test gas generators are used rather than test gas cylinders. Such handling, however, can be very difficult and can hardly be implemented at some locations where the spectrometer is used.

The reference points can be validated and/or calibrated, in particular if gases such as H₂O or HCl are to be calibrated, with great outlay in terms of technology and time. Reasons for this are as follows:
installation of the additional technical equipment such as test gas generator;
long setting times for HCl and H₂O;
wrong concentrations of the evaporator material can result in incorrect calibration.

The reference points are therefore validated and/or calibrated by trained specialists.

The reference points are therefore checked only at long intervals (e.g., there is no validation of the reference points for relatively long measurement intervals). This can lead to an increased risk of an incorrect indication of the concentrations.

U.S. Pat. No. 5,777,735, the disclosure of which is hereby incorporated by reference in its entirety, discloses a method and a device of this type, in which, as in other known methods, the device is calibrated for the respective gas component to be measured by supplying the corresponding gas in pure form as a calibration gas from a tank. This can be far too complicated for most gases.

### SUMMARY

A method is disclosed for operating a Fourier transform infrared spectrometer, comprising: performing, in cyclically recurring intervals, a validation/calibration of the spectrometer by recording with at least two gases both a reference spectrum with zero gas and an absorption spectrum with calibration gas; and simulating an actual measurement gas component with respect to metrological properties during validation of the spectrometer, using substitute gases as gas components.

A Fourier transform infrared (FTIR) spectrometer is disclosed, comprising: validation and/or calibration means for cyclically validating and/or calibrating a measurement spectrum of the FTIR spectrometer; and means for introducing substitute gases into a beam path of the spectrometer for calibration, the substitute gases being representative of actual measurement gases with respect to their absorption effect within the spectrometer.

### BRIEF DESCRIPTION OF THE DRAWINGS

In the figures:

FIG. 1 shows an exemplary FTIR spectrometer with a pivotable or slideable calibration cuvette;

FIG. 2 shows an exemplary control of calibration;

FIG. 3 shows an exemplary spectrum with representative guide components; and

FIG. 4 shows an exemplary division of a spectrum into regions.

The disclosure is illustrated and described in more detail below with reference to exemplary methods and procedures according to the disclosure, and with reference to exemplary constructions of a spectrometer.

### DETAILED DESCRIPTION

A method and a spectrometer are disclosed wherein, at each location of use and at all times, the spectrometer can be calibrated and/or validated.

When validating a spectrometer, in addition to or instead of actual measurement components, substitute gas components can be selected which are easy to handle and which can cover an entire spectral range of the spectrometer. In applications where gases which are difficult to handle are measured, such as HCl, HF, NH₃, for effective validation or calibration, the gases mentioned should be made available as test gases with high purity. As disclosed herein, easy-to-handle gases can be used as substitutes for the validation, which produce an absorption effect approximately in the region of the “difficult” gas, as a representative, as it were. These substitute gases are much easier to handle as validation or calibration gases than the actual measurement gases if the latter need to be made available in highly pure form and exact concentration for the calibration. Exemplary substitute gases which are by a long way not as aggressive or difficult to handle as those gases which they are meant to represent will be mentioned here in the text below. Validation and calibration thus become simpler on the whole.

In an exemplary embodiment, a gas mixture which contains (e.g., consists of) a plurality of substitute gases, is used for validation purposes. Each gas can be selected to cover a partial range of the entire measurement spectrum. It is possible in this way to incorporate the substitute gases for calibration into a gas mixture, which would be of concern alone from a chemical point of view with the actual gas components. In this manner, a complete desired spectral range of the spectrometer can be immediately validated in one step.

In exemplary embodiments, many substitute gases can be incorporated in the calibration/validation gas mixture such that they cover the entire spectral range of the spectrometer.

The intensities can be monitored in the validation/calibration step with zero gas, and thus the entire spectrum can be stored as a reference by way of interpolation.

The substitute gases can be supplied automatically to a measurement cuvette individually (e.g., from different gas tanks) or as a substitute gas mixture from a gas tank, by way of individual valve actuation, in an automatic validation/calibration step, and afterwards a corresponding validation and/or calibration can be performed (i.e., carried out). It is thus possible to automatically cyclically carry out the validation step in a simple and effective manner.

The ascertained validation and/or calibration values can be stored in an adaptive data field, from which it is also possible, if desired, to evaluate the validation/calibration history in order to obtain therefrom a diagnosis relating to a maintenance state of the spectrometer, if appropriate.

The substitute gas components can be closed off (e.g., enclosed), individually or as a substitute gas mixture in a calibration cuvette. For the purposes of carrying out the validation/calibration, the substitute gas components can be automatically pivoted into the beam path and then pivoted out again.

An FTIR spectrometer is also disclosed wherein gases are used for calibration which are representatives of actual measurement gases with respect to their absorption effect within the spectrometer and are stored within a gas tank, and can be automatically introduced into the beam path of the spectrometer in series one after another or as a gas mixture at the moment of the automatic initiation of a calibration or validation process.

In an exemplary embodiment of the spectrometer disclosed herein, the gases can be passed into the measurement cuvette of the spectrometer using a means for automatically introducing the gases, such as an automatic valve control or other suitable control device. It is thus possible to automatically initiate the calibration process and introduce the gases.

In an alternative embodiment, the means for automatically introducing the gases can include a device for automatically pivoting the gases into the beam path of the spectrometer in one or more calibration cuvettes which are closed off after filling with gas and which can be automatically pivoted out of the beam path again after calibration/validation. There is thus no need for the storing of gas.

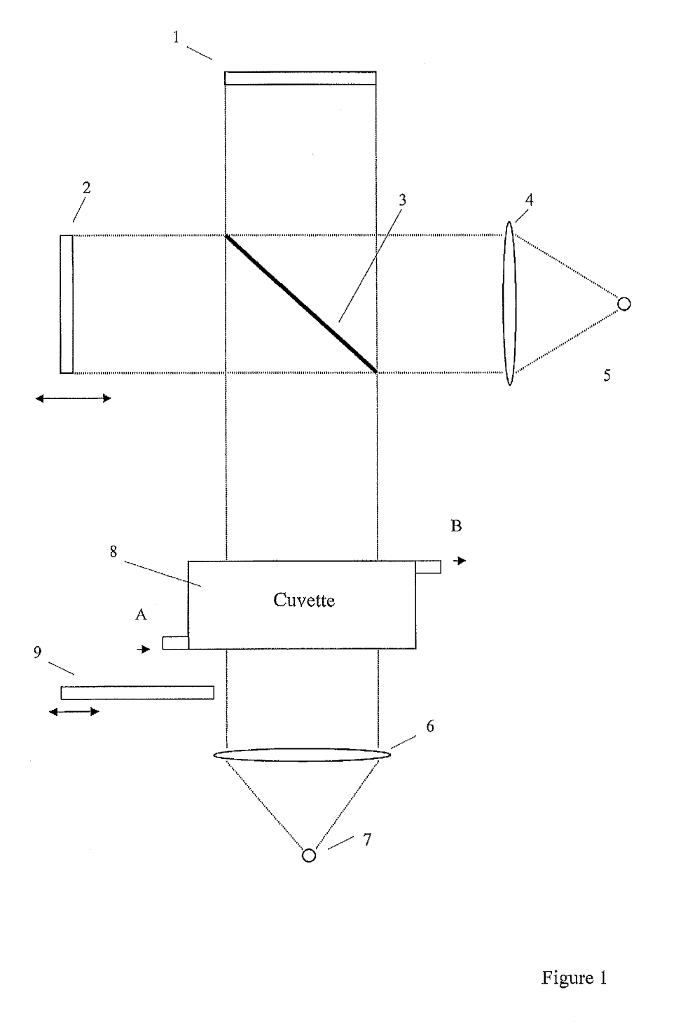

FIG. 1 shows an exemplary construction of an FTIR spectrometer which is based for example on a Michelson interferometer. Starting from a radiation source 5, a first optical system 4 is used to produce a parallel beam bundle by way of spreading, which beam bundle strikes a semi-transparent mirror 3 as a beam splitter. Some of the light with the fixed wavelength and frequency position (monochromatic and coherent) now falls onto the positionally fixed mirror 1 and is reflected there. The other partial light bundle passes in a straight line through the mirror 3 and is reflected by a moveable mirror 2 back in the direction of the mirror 3, where the two partial light beams now interfere with each other. The interference is here controlled in a deliberate fashion via the movement of the mirror 2 along the optical axis. From there, the interfered light travels through the measurement cuvette 8 through which measurement gas is passed. The interferometer can be used to achieve very exact tuning of the effective frequency position of the light bundle which strikes the measurement cuvette and thus the measurement gas. It is thus possible to detect a complete spectrum at the detector, rather than only the absorption rate at a fixed frequency. In order to illuminate the detector in an optimum fashion, a second optical system 6 can be used to focus the spread light bundle again, specifically onto the dimension of the detector.

The measurement cuvette contains a gas entry A and a gas exit B and the measurement gas is passed into it and then out of it again for the recording of a measurement spectrum.

To carry out an exemplary calibration step according to the disclosure, a valve control can be actuated, and calibration gas is passed, or flushed, through the cuvette 8 in order to pass in the measurement gas to be measured by a change in valve control after the calibration.

In another exemplary embodiment, the calibration gas is pivoted into the beam path upstream of the detector 7 or of the optical system 6 with the aid of calibration cuvettes 9, for as long as the calibration and/or validation takes. Thereafter the calibration cuvette is pivoted out of the beam path again.

In exemplary embodiments, the calibration cuvette is not filled with a relevant measurement gas or a measurement gas component which is measured in this calibrated portion of the spectrum, but with a substitute gas or substitute gas mixture representing the former. By way of example, SO₂, CO₂, N₂O or methane can be used, for example, as substitute gases, that is to say as representatives, over an exemplary spectral range of the spectrometer rather than the much more tricky gas components HCl, HF, NH₃ etc. The use of the latter in their pure form for calibration can be significantly more complicated. Instead, the use according to the disclosure of the substitute gases can significantly simplify the calibration/validation, since these substitute components mentioned are much easier to handle. They are so easy to handle that they can also be handled for calibration in closed-off calibration cuvettes rather than in methods where gas is passed through. This would not be possible in this way with HCl or HF or even with steam H₂O.

If calibration cuvettes are used, the individual gases can likewise be enclosed in each case in one calibration cuvette and can be pivoted in alternately in the manner of an aperture wheel. It is also possible to use, as in the method where gas is passed through, a gas mixture of all the substitute gases in a common calibration cuvette 9.

Instead of pivoting the calibration cuvette in, it is of course also possible to slide it in with a linear motion, or in any desired, suitable fashion.

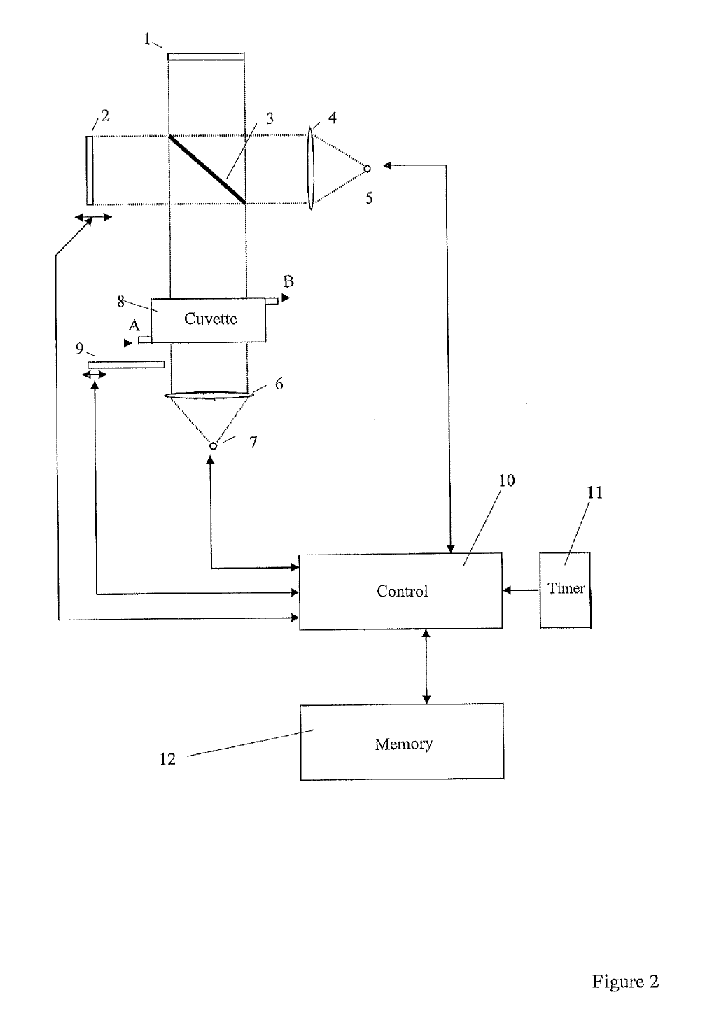

FIG. 2 shows an exemplary control of an FTIR according to the disclosure. Here, a control unit 10 is used to actuate the light source 5 (laser) and the detector 7. A timer unit 11 triggers the calibration process at a time that can be set or by way of an intentional drive signal. For this, the mirror 2, the light source 5 and the detector 7 can now be controlled in a coordinated fashion, and in addition the pivoting or sliding actuation of the calibration cuvette 9 can be controlled in a coordinated fashion and in such a way that the reference spectrum is recorded and stored in the adaptive storage unit 12. Moreover, the storage unit 12 writes the data with temporal assignment as historic data, whereupon additionally an evaluation of possible aging effects can be detected. Moreover, it is also possible to carry out, in addition to the pure calibration, a sustained self-diagnosis of the spectrometer.

As an exemplary alternative to the actuation of the pivoting or sliding movement of the calibration cuvette, it is also possible instead to actuate in a coordinated fashion the valve control for supplying substitute gases in the method where gas is passed through, in order to be able to carry out the calibration also in this manner with the use of the stated substitute gases.

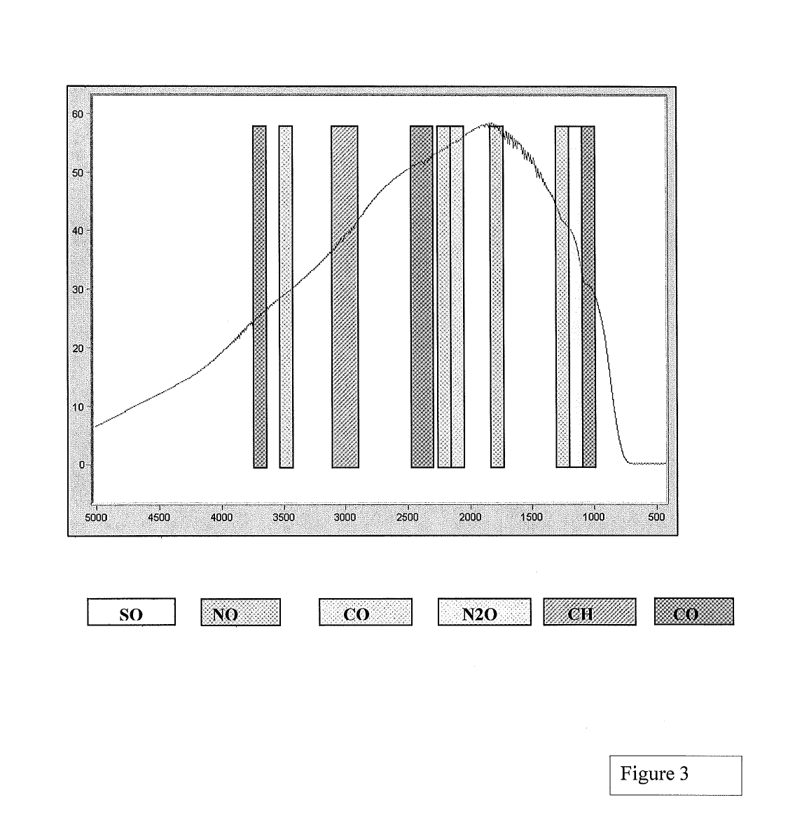

FIG. 3 shows how a validation (check) can be carried out using a test gas mixture of a plurality of substitute gases rather than a test gas submission for all components. The substitute gases can all be mixed together in a test gas cylinder and are stable for a relatively long period of time. The substitute gases can also be measurement gas components, such as SO₂ or CO₂. Alternatively, or additionally, however, it is also possible to use gases with many absorptions in various wavelength ranges, for example stable halogenated hydrocarbons or N₂O and CO₂. The substitute gases can, for example, cover an entire spectral range (or any desired range) of the spectrometer.

By way of example, the following substitute gases can be used therefor.
long-wave range, for example with SO₂;
medium range, for example with CO₂;
short-wave range by way of methane of N₂O.

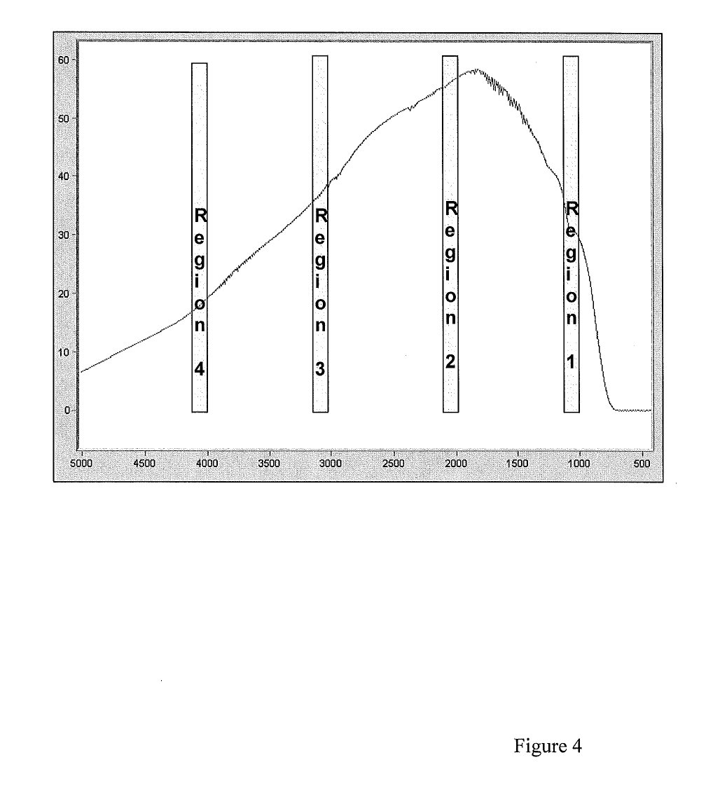

FIG. 4 shows how additionally the intensities of the reference spectrum can be monitored. Thus, the wavelength ranges which are not covered by the substitute gases can also be monitored.

If during the validation of the spectrometer no changes for the substitute gases occur or no changes in the zero points occur for the individual ranges of the reference spectrum, there are also no changes for the remaining measurement components (for example HCl or HF).

In contrast to the validation/calibration with test gas generators, the whole procedure can be automated. That is to say, it is possible to submit the test gas mixture of substitute gases and the zero gas for the reference spectrum via solenoid valves as described in a computer-controlled fashion. The results can be evaluated automatically and it is possible to trigger an alarm, if appropriate. It is also possible in the case of slight deviations for a pre-alarm to be triggered.

Storing the history of the results of the validation can be used as a basis for continuous quality control. Additionally, the spectra for guide components and reference values can be stored, as already described.

Alternatively, it is possible to completely dispense with a test gas cylinder with the mixture of substitute gas components by stably enclosing the substitute gas components in a calibration cuvette. Instead of a test gas submission via solenoid valves, the calibration cuvette(s) is/are then, as described above, cyclically pivoted into the optical path.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SIGNS

1 mirror, positionally fixed
2 mirror, moveable
3 semi-transparent mirror/beam splitter
4 optical system, spreading
5 beam source
6 optical system, focusing
7 detector
8 measurement cuvette
9 calibration cuvette
10 control
11 timer control
12 adaptive data memory
A measurement gas entry
B measurement gas exit

What is claimed is:

1. A method for operating a Fourier transform infrared spectrometer, comprising:
performing, in cyclically recurring intervals, a validation/calibration of the spectrometer by recording with at least two gases both a reference spectrum with zero gas and an absorption spectrum with calibration gas; and
simulating an actual measurement gas component with respect to metrological properties during validation of the spectrometer, using substitute gases as gas components.

2. The method as claimed in claim 1, wherein the at least two gases are a gas mixture containing a plurality of substitute gases which each cover a partial range of an entire measurement spectrum.

3. The method as claimed in claim 2, wherein substitute gases are incorporated in the gas mixture to cover the entire spectral range of the spectrometer.

4. The method as claimed in claim 1, comprising:
monitoring intensities of the reference spectrum in the validation/calibration with zero gas; and
storing the entire spectrum as a reference by using interpolation.

5. The method as claimed in claim 1, comprising:
automatically supplying the substitute gases to a measurement cuvette for the validation/calibration.

6. The method as claimed in claim 5, comprising:
storing ascertained validation and/or calibration values in an adaptive data field as a validation/calibration history.

7. The method as claimed in claim 1, comprising:
enclosing the substitute gases in a calibration cuvette;
automatically pivoting the substitute gases into a beam path for carrying out the validation/calibration; and
pivoting the substitute gases out of the beam path.

8. A Fourier transform infrared (FTIR) spectrometer, comprising:
validation and/or calibration means for cyclically validating and/or calibrating a measurement spectrum of the FTIR spectrometer; and
means for introducing substitute gases into a beam path of the spectrometer for calibration, the substitute gases being representative of actual measurement gases with respect to their absorption effect within the spectrometer.

9. The FTIR spectrometer as claimed in claim 8, comprising:
a measurement cuvette; and
an automatic valve control for passing the substitute gases to the measurement cuvette.

10. The FTIR spectrometer as claimed in claim 8, comprising:
at least one calibration cuvette for automatically pivoting the substitute gases into the beam path of the spectrometer, the at least one calibration cuvette being closed off after filling with gas and automatically pivoted out of the beam path after calibration/validation.

11. The method as claimed in claim 5, wherein each of the substitute gases is supplied from a different gas tank.

12. The method as claimed in claim 6, comprising:
evaluating the validation/calibration history to diagnose a maintenance state of the spectrometer.

13. The method as claimed in claim 7, wherein the substitute gases are individually pivoted into a beam path and pivoted out of the beam path for the validation/calibration.

14. The FTIR spectrometer of claim 8, comprising:
at least one gas tank for storing the substitute gases.

15. The FTIR spectrometer of claim 8, wherein the means for introducing introduces each of the substitute gases sequentially into the beam path.

16. The FTIR spectrometer of claim 8, wherein the means for introducing introduces the substitute gases into the beam path as a gas mixture at a moment of automatic initiation of the validating and/or calibrating.
